(19) United States
(12) Patent Application Publication
(10) Pub. No.: US 2008/0244262 A1
(43) Pub. Date: Oct. 2, 2008

(54) ENHANCED SUPPLICANT FRAMEWORK FOR WIRELESS COMMUNICATIONS

(75) Inventors: Jianghong Du, Shanghai (CN); Chuan Song, Shanghai (CN)

Correspondence Address: GROSSMAN, TUCKER, PERREAULT & PFLEGER, PLLC;C/O Intellevate, LLC, P. O. BOX 52050, MINNEAPOLIS, MN, 55402, US

(73) Assignee: Intel Corporation, Santa Clara, CA (US)

(21) Appl. No.: 11/694,450

(22) Filed: Mar. 30, 2007

(51) Int. Cl. H04L 9/00

(52) U.S. Cl. 713/155

(57) ABSTRACT

The present disclosure provides a method that may be used in wireless communications. According to one exemplary embodiment, the method may include partitioning a first device into a user operating system including a supplicant client and a secure operating system including a supplicant core. The method may also include performing a user authentication process at the supplicant core. The method may further include transmitting user authentication data from the supplicant core to at least one wireless network and accessing the supplicant core from at least one additional device. Of course, additional embodiments, variations and modifications are possible without departing from this embodiment.

### FIELD

The present disclosure describes an enhanced framework over Extensible Authentication Protocol (EAP) for use with wireless networks.

### BACKGROUND

As wireless communications increase in popularity, accessing a particular network may require a secure authentication method. Some of this authentication may be provided using the Subscriber Identity Module (SIM) card, present in many cell phones. Extensible Authentication Protocol Method for GSM Subscriber Identity (EAP-SIM) is an EAP authentication standard, designed for use with existing Global System for Mobile Communications (GSM) mobile telephone authentication systems. However, the current EAP-SIM framework has a number of constraints and may not provide the necessary security.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is diagram of a system in accordance with one exemplary embodiment of the present disclosure;

FIG. 2 is a diagram of a system in accordance with yet another exemplary embodiment of the present disclosure;

FIG. 3 is a diagram of a system in accordance with an additional exemplary embodiment of the present disclosure; and

FIG. 4 is a flowchart showing another exemplary embodiment depicting operations in accordance with the present disclosure.

Although the following Detailed Description will proceed with reference being made to illustrative embodiments, many alternatives, modifications, and variations thereof will be apparent to those skilled in the art.

### DETAILED DESCRIPTION

Traditionally, EAP-SIM authentication and the associated network application work together closely in the same operating system (i.e. the same partition). As a result, each end user may require his/her own SIM card to process the authentication because the SIM card authentication module may be tightly bound with the network application (i.e, user application). Communications sent during the authentication process (e.g., between a portable device, such as a laptop and an access point (AP) such as a router) may be subject to public network hackers. In these instances, the user operating system may become infected. The data in the laptop as well as the data in the SIM card may be destroyed or disclosed.

Generally, this disclosure provides a system and method for an enhanced supplicant framework for wireless communications. The methods described herein may be used in order to protect the user operating system by placing the EAP-SIM authentication process and the network application in different partitions. In some embodiments, virtualization technology may be used to separate user privacy data from the public network so that this supplicant framework may be used conveniently and safely.

The term “supplicant” as used herein, may be used in accordance with the IEEE 802.1X standard, where the supplicant is an entity at one end of a point-to-point LAN segment that seeks to be authenticated by an authenticator (e.g., authentication server 107 described below) attached to the other end of that link. IEEE 802.1X is an IEEE standard for port-based Network Access Control and is included as part of the IEEE 802 (802.1) group of protocols. It may provide authentication to devices attached to a LAN port, establishing a point-to-point connection or preventing access from that port if authentication fails. It may be used for certain closed wireless access points, and is based on the EAP. 802.1X is available on certain network switches, and may be configured to authenticate hosts which are equipped with supplicant software, denying unauthorized access to the network at the data link layer.

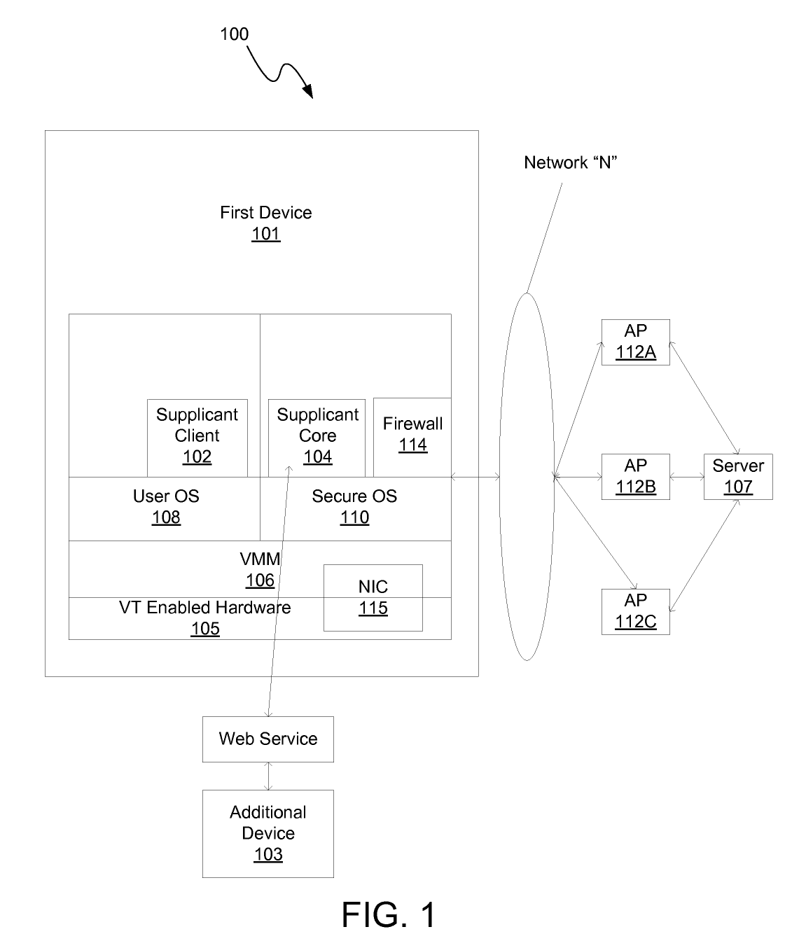

Referring now to FIG. 1, an exemplary embodiment of a system 100 for an enhanced supplicant framework is shown. System 100 may include a first device 101 and at least one additional device 103. Devices 101 and 103 may include PCs, laptops, personal digital assistants (PDAs), cellphones or any other device capable of accessing the Internet. First device 101 may include supplicant client 102 and supplicant core 104, which may each be enabled under a virtualization technology (VT) platform using. VT enabled hardware 105 may allow a platform to run multiple operating systems and applications in independent partitions. For example, a virtual machine monitor 106 (i.e., hypervisor) may manage a first partition, such as user operating system 108 and a second partition, such as secure operating system 110. This configuration may allow for both operating systems to run on a host computer, such as first device 101 at the same time.

System 100 may also allow for multiple devices to access a wireless network by sharing one supplicant core 104. For example, first device 101 may communicate through network “N” with various access points 112 (e.g., routers 112A, 112B, and 112C). Routers 112 may be in communication with numerous other devices such as server 107. In some embodiments, server 107 may be an authentication server such as a Remote Authentication Dial In User Service (RADIUS) server. System 100 also allows for other devices, such as additional device 103 to communicate through network “N” by using a web service to access supplicant core 104 of device 101. Network “N”, as used herein, may refer to a hotspot or any network offering wi-fi access.

In some embodiments, supplicant client 102 may be configured to run on user operating system 108. In contrast, supplicant core 104 may be configured to run on secure operating system 110 and may also process certain authentication operations such as EAP-SIM. Secure operating system 110 may be configured to integrate an enhanced security firewall 114 and may also be responsible for transmitting EAP-SIM data. In some embodiments, supplicant core 104 may be shared with a plurality of devices, such as additional device 103. Device 101 may further include a network interface controller 115 (NIC) and/or other hardware devices that may be used in the field of network communications.

In operation, the data transmitted from supplicant client 102 to supplicant core 104 (or alternatively from core 104 to client 102) may comply with the Simple Object Access Protocol (SOAP) web services messaging framework. Supplicant core 104 may act as an authentication module and may be shared among a plurality of supplicant clients (e.g., additional device 103). For example, a second supplicant client (not shown) located in additional device 103, separate from supplicant core 104, may communicate with supplicant core 104 using a variety of different communication methodologies. Some of these communication techniques, may include, but are not limited to, Bluetooth, infrared, radio, ultrasonic and microwave communications systems.

System 100 may allow several end users (e.g., first and second devices 101 and 103) to share the same authentication platform having the pre-authentication process necessary for the transmission of EAP-SIM data. Further, the authentication data may access the network through secure operating system 110. Thus, if the authentication data is attacked during transmission, user operating system 108 may be prevented from transmitting any data, thus shielding user operating system 108 from the attack.

In some embodiments, system 100 may be used to protect privacy data present in a SIM card. The SIM card may be configured to encrypt voice and data transmissions and to store data specific to a particular user so that the user may be identified and authenticated to the network supplying a phone service. Secure operating system 110 may be configured to notify a cell phone if there are security breaches between secure operating system 110 and the outside network. Thus, minimizing and/or preventing any losses at the SIM card.

System 100 may be configured to apply different security settings to various operations within the same network application. For example, EAP-SIM operations within the network application may be set to a higher security level while alternative operations may be set to a lower security level. Moreover, system 100 may simplify the migration of the network application onto new platforms. If the network application is migrated to another type of operation system, another EAP-SIM authentication process may not be required. Thus, secure operating system 110 may be migrated to the new platform without the need for software modification.

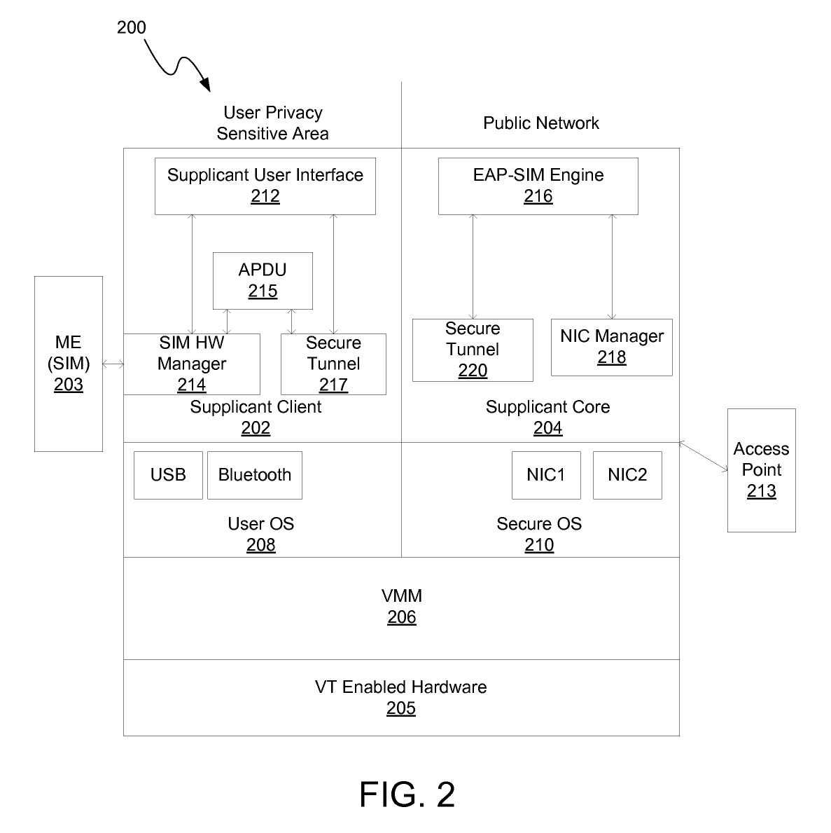

Referring now to FIG. 2, an exemplary embodiment of a system 200 depicting an enhanced supplicant framework is shown. System 200 may include supplicant client 202 and supplicant core 204. System 200 may also include, inter alia, SIM 203, a virtualization technology enabled platform 205 and a virtual machine monitor 206 configured to allow multiple operating systems to run on a host computer simultaneously.

In some embodiments, client 202 and core 204 may be used in accordance with the EAP-SIM protocol mechanism for authentication and session key distribution. In accordance with this embodiment, supplicant client 202 may reside on user operating system 208 and may include a number of components. For example, supplicant client 202 may include supplicant user interface 212, subscriber identity module (SIM) hardware manager 214, application protocol data unit (APDU) message agent 215, and secure tunnel 217.

Supplicant core 204 may reside within secure operating system 210 and may include EAP-SIM protocol engine 216, network interface controller (NIC) manager 218 and secure tunnel 220. Secure operating system 210 may also include a firewall (not shown), which may be configured to filter all incoming network packets. Any malicious packets may be blocked and prevented from interacting with the user operating system 208.

Using the framework provided by system 200 the user operating system 208 may be safely separated from the public network. Thus, all user privacy data operations may be constrained within an area trusted by the user. Further, supplicant client 202 and supplicant core 204 may work through separate web service interfaces, which may allow additional supplicant clients to access supplicant core 204.

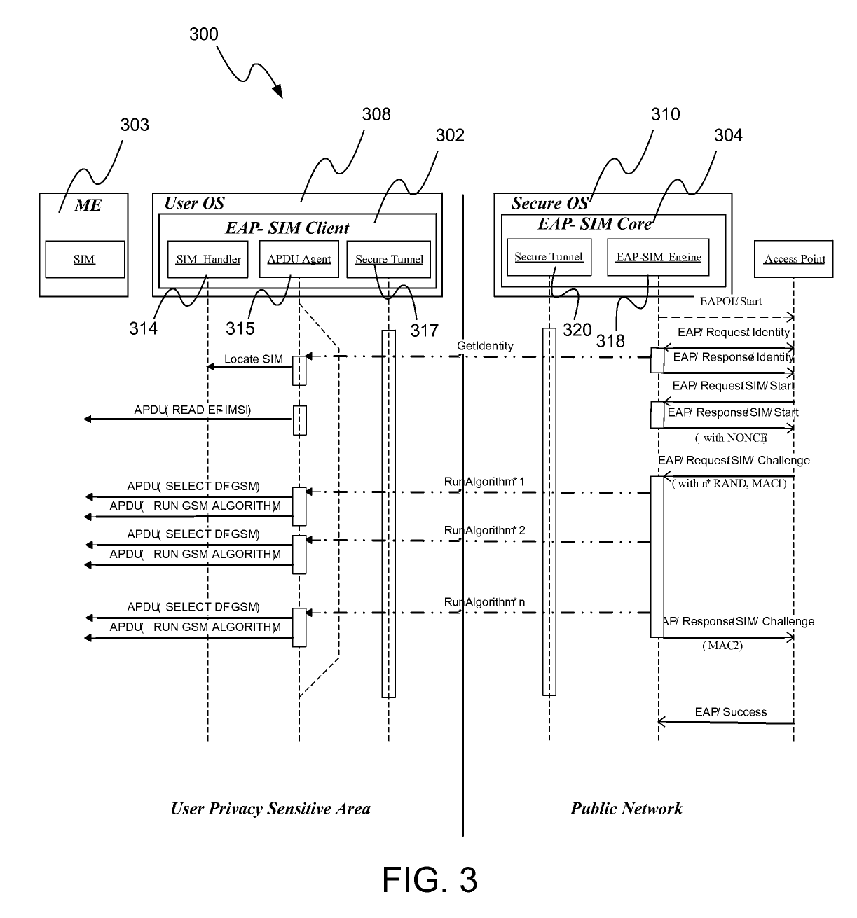

Referring now to FIG. 3, a system 300 is shown in accordance with yet another exemplary embodiment of the present disclosure. System 300 may include EAP-SIM client 302 associated with user operating system 308 and EAP-SIM core 304 associated with secure operating system 310. EAP-SIM core 304 may be accessible via a public network and may include secure tunnel 320 and EAP-SIM engine 316. In contrast, EAP-SIM client 302 and portable device 305 may be shielded from the public network as described above.

In some embodiments, after EAP-SIM Engine 318 receives the EAP request message from outside network (e.g., from the access point), it may parse the EAP message and communicate with EAP-SIM Client 302 to obtain related SIM data through Secure Tunnels 320 and 317. Secure tunnels 317 and/or 320 may shield EAP-SIM Client 302 and User operating system 308 from attacks from the public network. After APDU Agent 315 receives the data it may construct an APDU message and communicate with the SIM to obtain the relevant SIM data. APDU Agent 315 may convert the SIM data to the format required by EAP-SIM Engine 318. The access point may then receive the EAP response message constructed by EAP-SIM Engine 318.

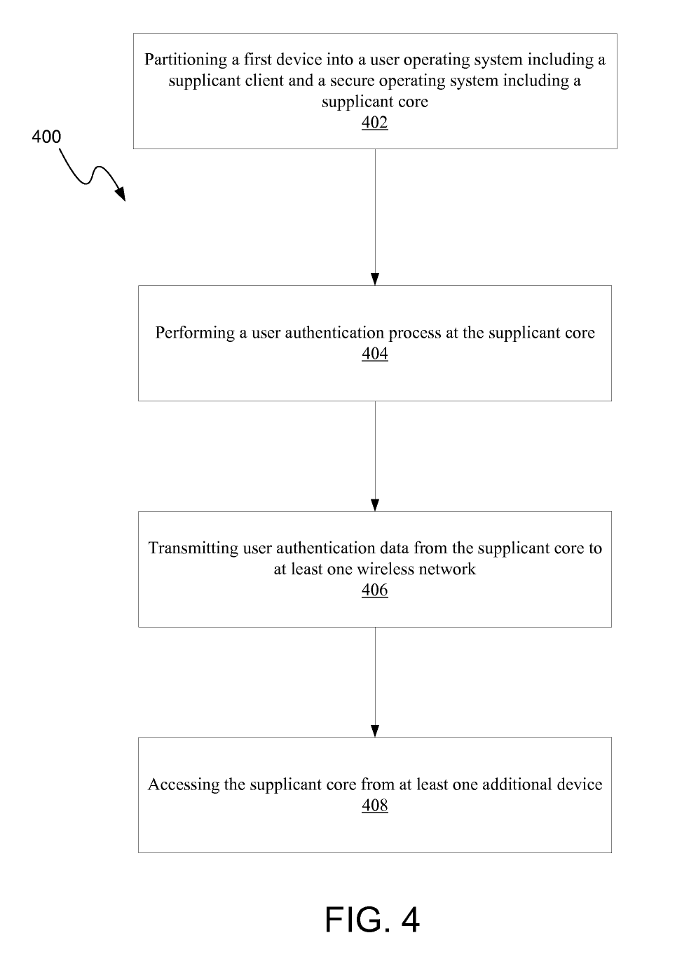

FIG. 4 depicts a flowchart 400 of exemplary operations consistent with the present disclosure. Operations may include partitioning a first device into a user operating system including a supplicant client and a secure operating system including a supplicant core (402). Operations may also include performing a user authentication process at the supplicant core (404). Operations may further include transmitting user authentication data from the supplicant core to at least one wireless network (406). Operations may additionally include accessing the supplicant core from at least one additional device (408). Of course additional operations are also within the scope of the present disclosure. It should be understood that any of the operations and/or operative components described in any embodiment herein may be implemented in software, firmware, hardwired circuitry and/or any combination thereof.

The described embodiments may be used in accordance with additional authentication frameworks in addition to the EAP-SIM protocol mechanism described herein. Some additional authentication frameworks may include, but are not limited to, Lightweight Extensible Authentication Protocol (LEAP), EAP-Transport Layer Security (EAP-TLS), EAP-MD5, EAP-PSK, EAP-Tunneled Transport Layer Security (EAP-TTLS), EAP-Internet Key Exchange Protocol version 2 (EAP-IKEv2), PEAP, EAP-Flexible Authentication via Secure Tunneling (EAP-FAST), and EAP for Universal Mobile Telecommunications System Authentication and Key Agreement (EAP-AKA).

Embodiments of the methods described above may be implemented in a computer program that may be stored on a storage medium having instructions to program a system to perform the methods. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic operations. Other embodiments may be implemented as software modules executed by a programmable control device.

Accordingly, at least one embodiment described herein may provide a system comprising a first device including a supplicant client configured to run on a user operating system and a supplicant core configured to run on a secure operating system. The supplicant core may be configured to perform a user authentication process and the secure operating system may be configured to transmit data to at least one wireless network. The system may include at least one additional device configured to access the supplicant core.

The embodiments described herein may provide numerous advantages over the prior art. For example, several client devices may be configured to share one SIM authentication module in order to perform the authentication processes. Further, the user operating system may be protected from potential hackers because the communications with the outside network may only involve the secure operating system.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. A system comprising:
a first device including a supplicant client configured to run on a user operating system and a supplicant core configured to run on a secure operating system, the secure operating system configured to transmit data to at least one wireless network and the supplicant core configured to perform a user authentication process; and
at least one additional device configured to access the supplicant core.

2. The system according to claim 1, wherein the data is Extensible Authentication Protocol Method for GSM Subscriber Identity Module (EAP-SIM) data.

3. The system according to claim 1, wherein the at least one additional device is configured to access at least one network through the supplicant core.

4. The system according to claim 1, wherein the user authentication process includes the authentication of a Subscriber Identity Module Card.

5. The system according to claim 3, wherein the at least one additional device accesses the at least one network via a second supplicant client configured to communicate with the supplicant core of the first device.

6. The system according to claim 5, wherein the second supplicant client communicates with the supplicant core of the first device using at least one of Bluetooth, infrared, radio, ultrasonic and microwave communications.

7. The system according to claim 1, wherein the user operating system and the secure operating system are managed via a virtual machine monitor.

8. The system according to claim 7, wherein the first device includes a virtualization technology enabled platform.

9. A method comprising:
partitioning a first device into a user operating system including a supplicant client and a secure operating system including a supplicant core;
performing a user authentication process at the supplicant core;
transmitting user authentication data from the supplicant core to at least one wireless network; and
accessing the supplicant core from at least one additional device.

10. The method according to claim 9, further comprising authenticating data relating at least in part to a Subscriber Identity Module Card.

11. The method according to claim 9, further comprising communicating between a second supplicant client associated with the at least one additional device and the supplicant core of the first device.

12. The method according to claim 11, wherein the communicating includes at least one of Bluetooth, infrared, radio, ultrasonic and microwave communication.

13. The method according to claim 9, further comprising managing the user operating system and the secure operating system via a virtual machine monitor.

14. The method according to claim 9, further comprising accessing the at least one network from the at least one additional device.
